(19) United States
(12) Patent Application Publication
(10) Pub. No.: US 2023/0373114 A1
(43) Pub. Date: Nov. 23, 2023

(54) HAIR CUTTING DEVICE WITH DISPLAY

(71) Applicant: Braun GmbH, Kronberg (DE)

(72) Inventors: Wolfgang Stegmann, Moerfelden (DE); Bernhard SIKORA, Kelkheim (DE); Lingxuan KONG, Frankfurt (DE)

(21) Appl. No.: 18/199,398

(22) Filed: May 19, 2023

(30) Foreign Application Priority Data
May 19, 2022 (EP) 22174252.1

(51) Int. Cl. B26B 19/38

(52) U.S. Cl. CPC B26B 19/3853; B26B 19/3886; B26B 19/388

(57) ABSTRACT

The present invention relates to a hair cutting device, such as an electric shaver or trimmer, comprising a handle and a hair cutting tool, said handle being provided with an outer shell, a battery, a motor, an on/off button, a display for indicating a functional status of the device by at least one of images, text, figures symbols, a PCB electrically connected to a part of said display, said battery and said motor, wherein said on/off button being provided on a same side of said outer shell as said display and wherein said hair cutting tool being located at a top end of the device opposite to a bottom end thereto.

### FIELD OF THE INVENTION

The present invention relates to a hair cutting device, such as an electric shaver or trimmer, comprising a handle and a hair cutting tool, said handle being provided with an outer shell, a battery, a motor, an on/off button, a display for indicating a functional status of the device by at least one of images, text, figures symbols, a PCB electrically connected to a part of said display, said battery and said motor, wherein said on/off button being provided on a same side of said outer shell as said display and wherein said hair cutting tool being located at a top end of the device opposite to a bottom end thereto.

### BACKGROUND OF THE INVENTION

Hair cutting devices, such as electric shavers, wet razors, trimmers or hair clippers are provided with at least one blade at the top end and a handle connected therewith. The handle is shaped such that it can be well gripped by the user's hand and an on/off button provided for switching an internal motor on and off is located on one side of a outer shell of the handle. Further the known shavers and other hair cutting devices are provided with some displaying means for displaying a shaver function, as e.g. battery load status or on/off status or a specific shaving mode via a display. In order to avoid that the user's hand is not covering the display, said display is provided below the on/off button more remote from the top of the device. Further, finger gripping ribs may be provided on the other shell of known hair cutting devices with e.g. a protruding elastomer grip ribs embedded into the outer shell. An issue with such a traditional design is that many openings are provided within the outer shell of the handle for an on/off button, maybe an extra mode button, some displays and some portions intended to enhance the gripping which is critical as more and more hair cutting units are used in a wet surrounding and water may pass though small gaps of those openings.

### SUMMARY OF THE INVENTION

It is an objective underlying the present invention to provide for an improved ergonomic design of a hair cutting device as e.g. an electric shaver reducing the number of holes through the outer shell provided for different features of the user interface while assuring an improved grip and usability. It is a further objective that a display of said hair cutting device can be well read independent from the present illumination situation. It is yet another objective to improve the device such that scratches may not damage said display.

To achieve at least one of the aforementioned objectives, a hair cutting device having the features of claim 1 is provided. Further advantageous provisions are set forth with the features of the dependent claims.

A hair cutting device is, such as an electric shaver or trimmer is suggested, comprising a handle- and a hair cutting tool, said hair cutting tool is provided within a head which is supported such on said handle to allow swivel motion of said head and said cutting tool comprises at least three separate hair cutting units. said handle being provided with an outer shell, a PCB, a battery, a motor, an on/off button, a display for indicating a functional status of the device by at least one of images, text, figures symbols, wherein a part of said display and said on/off button or switch being electrically connected to first side of said same PCB and said battery and said motor being electrically connected to a second side of said same said PCB opposite to said first side, wherein said on/off button or switch being provided on a same frontal side of said outer shell as said display and wherein said hair cutting tool being located at a top end of the device opposite to a bottom end thereto, wherein said display being provided closer to the top end of the device than said on/off button and wherein said display also forming a thumb rest area. Alternatively a hair cutting device, such as an electric shaver or trimmer, is also suggested, comprising a handle and a hair cutting tool, said handle being provided with an outer shell, a battery, a motor, an on/off button, a display for indicating a functional status of the device by at least one of images, text, figures symbols, a PCB electrically connected to a part of said display, said battery and said motor, wherein said on/off button being provided on a same side of said outer shell as said display, wherein said hair cutting tool being located at a top end of the device opposite to a bottom end thereto, wherein said display being provided closer to the top end of the device than said on/off button and wherein said display also forming a thumb rest area.

Thus, the display may be used for a dual functionality: displaying shaver information but also providing a thumb rest area that enhances the grip of the device without further ribs or other surface structuring features needed which would require additional housing openings. Further, the operative usage of the shaver may be very intuitive as the thumb is to be positioned directly onto the display which is located just above and adjacent the on/off button. Accordingly, only with a small thumb shift the shaver is safely handled with the thumb being placed onto a designated thumb rest area and then switched on or off by activating the adjacent on/off button. It may sound counter-intuitive to rest the thumb on a display as the display is then covered by the thumb and no longer readable. It revealed however that the benefits of a designated thumb rest area next to and above the on/off button are higher and that the user just moves the thumb away for reading the display. Further, the side-by-side arrangement of display and on/off button switch on the one side of the PCB and the motor and battery on the other side of the PCB eases to connect the electric parts with the PCB. Preferably the battery is arranged more remote from the top end than the motor so that the PCB also extends to a side of the battery in order to assure also electric connection between battery and PCB with short connecting means.

### BRIEF DESCRIPTION OF THE DRAWINGS

The present disclosure will be further elucidated by a detailed description of example embodiments and with reference to figures. In the FIGS.

FIG. 1 is a schematic front view of a hair cutting device according to a first embodiment,

FIG. 2 is a schematic cross-sectional view along the lines A-A in FIG. 1,

FIG. 3 is a schematic front view of a handle of the device according to a second embodiment,

FIG. 4 is a schematic front view of a handle of the device according to the first embodiment,

FIG. 5 is a schematic front view of a handle of the device according to a third embodiment,

FIG. 6 is a schematic front view of a handle of the device with a user hand,

FIG. 7a is a perspective view of a variant a of an outer window part with a part of a surrounding outer shell

FIG. 7b is a cross-sectional view along line B-B in FIG. 7a

FIG. 8a is a perspective view of a variant b of an outer window part with a part of a surrounding outer shell

FIG. 8b is a cross-sectional view along line C-C in FIG. 8a

FIG. 9a is a perspective view of a variant c of an outer window part with a part of a surrounding outer shell and

FIG. 9b is a cross-sectional view along line D-D in FIG. 9a.

### DETAILED DESCRIPTION OF THE INVENTION

A hair cutting device is provided, such as an electric shaver or trimmer, comprising a handle and a hair cutting tool. Said hair cutting tool, preferably including 1, 2, 3, 4, 5 or 6 separate hair cutting units, being located at a top end of the device opposite to a bottom end thereto. Said handle being provided with: an outer shell, a battery, a motor, an on/off button, a display for indicating a functional status of the device by at least one of images, text, figures symbols, and a PCB electrically connected to a part of said display, said battery and said motor. Said on/off button being provided on a same (front) side of said outer shell as said display, wherein said display being provided closer to the top end of the device than said on/off button and wherein said display is also forming a thumb rest area. Said thumb rest area is an area which is differentiated/separated from the surrounding outer shell and provides an area substantially fitting with the shape of the thumb to be rested thereon. It may be provided with additional features for assuring a finger stop.

More particularly, said hair cutting tool is provided within a shaver head which is supported such on said handle to allow swivel motion of said head and/or said cutting tool comprises at least 3 separate hair cutting units. Such larger shaver heads with at least 3 hair cutting units (each with upper and lower blade) which are also moveably supported need, create a momentum during usage relative to the handle so that safe handling due to the above ergonomic features is assured.

More particularly, said outer shell is provided with a display opening, said display comprises an outer window part fitting in said display opening and said part of said display connected to said PCB includes an electronic display element. Thus, the display includes several parts and eases that the outer window part may be specifically shaped to allow for good thumb rest properties different to those on the outer shell. Said outer window part includes a central main portion and a rim portion. A depressed central main portion of the outer window part provides good thumb rest properties as the rest of the outer shell is bulging outwardly or convexly rounded if seen in a horizontal cross-section.

More particularly, said outer window part is a one-piece part made from plastic and is formed with a depression and/or wherein said rim portion is substantially flush mounted with the adjacent outer shell and said central main portion is recessed or depressed relative to the rim portion. Thus, the outer window part is formed like a tub with a depressed central portion and finger stop properties towards the rim portion. By that the user intuitively knows that this is shaped for resting the thumb therein.

More particularly, said window part is a 2-component injection molded part having a transparent central main portion and a non-transparent rim portion.

More particularly, said on/off button is part of the window part.

More particularly, said rim portion is provided with a at least 0.5 mm wide top portion which is substantially flush mounted with the outwardly adjacent outer shell and is provided with an inwardly adjacent inclined portion, wherein said inclined portion connects the central main portion with the top portion. More preferably said rim portion is 1-3 mm wide. By this the thumb rest portion is framed by the rim which also assures good mechanical connectivity with the outer shell and also overall stability despite a rather thin main portion of the outer window. The transition between the outermost top portion of the rim portion and the main portion is inclined by an angle between 25 and 75 degree. Such an inclined transitioning not only assures comfortable finger stop properties but also good cleanability of the outer window.

More particularly, said PCB, said display and said motor are positioned next to each other side by side with the PCB being located between said display and said motor. This eases to connect both the motor and the electronic display with the PCB. Preferably the battery is arranged more remote from the top end than the motor so that the PCB also extends to a side of the battery in order to assure also electric connection between battery and PCB with short connecting means.

More particularly, said thumb rest area is depressed or recessed relative to the outer shell. This indentation or tub shape of the thumb rest area provides said different outer shape for accommodating the thumb thereon relative to the outwardly bulging or other shape of the outer shell next to the display.

More particularly, said display or said electronic display element is provided as one of a LCD, TFT, Touch-display, QLED, OLED, LED's, AMOLED, or Super AMOLED type. Preferably, the display is thus able to visualize symbols, text, and numbers. Alternatively, the visualization may happen by LED's. Further the display may be a so-called touch display which reacts on finger touches at least in some areas thereof. The on/off button may be part of the display.

More particularly, wherein said display includes a sensory area for activating and/or deactivating a hair cutting device function. As examples of such a hair cutting function the activation of the device, the operation under a different mode (like change of motor speed) or different display setting may be options.

More particularly, said display allows for gesture or finger swipe control of a hair cutting device function. Thus, the user handling of the hair cutting device may be similar to that of gesture controls of a smart phone. As most users are meanwhile used to control the smart phone by finger gestures acting onto the display an intuitive handling in a similar way of a shaver may be assured. As a function e.g. different operation modes may be selected and with a fingertip onto a touch sensitive display surface also selected.

More particularly, said outer shell is made of metal. As the manufacture of openings through metal housings is an extra step and as more openings may lower the stability of the outer shell, the above described display concept allows to reduce the number of openings and allows easy manufacture. As metals, aluminum or steel or alloys of that may be used.

More particularly, a water sealed inner shell is provided for accommodation of said PCB, electronic display element, battery, and motor. Thus, two housing shells are provided: an outer and an inner shell. This allows to focus the inner shell on functional aspects only. The electronic display is arranged such within the inner shell that it is located just adjacent the outer window. The images of the electronic display are thus readable through a translucent or transparent inner shell wall and an outer window part.

More particularly, said outer window is translucent and dark (e.g. black dyed) colored. This on the one side allows the illuminated parts of the electronic display to be seen through the window and the other side avoids that non displayed or non-illuminated parts can be seen as well through the window.

More particularly, a user interface includes said display and said on/off button and/or at least one mode button and wherein said outer shell is provided with a single display opening for accommodating therein all parts of the user interface and/or wherein said outer window part is provided with the user interface. Thus, the overall required number of openings in the outer shell for accommodating therein operations buttons and display's is one.

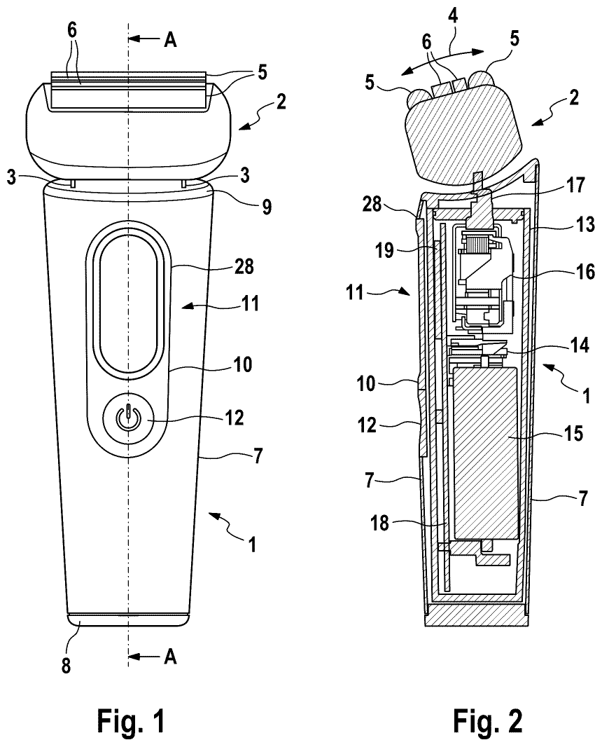

As shown with FIG. 1 an electric shaver is illustrated as an example of a hair cutting device. The shaver is provided with a handle 1 and a head 2. Said head is supported via support arms 3, so that it is able to swivel along arrow 4 in FIG. 2. Said head further comprises as at least 3 hair cutting tools 5, 6, which are here, by example, provided as two short hair cutting units 5 and two long hair center trimmers 6.

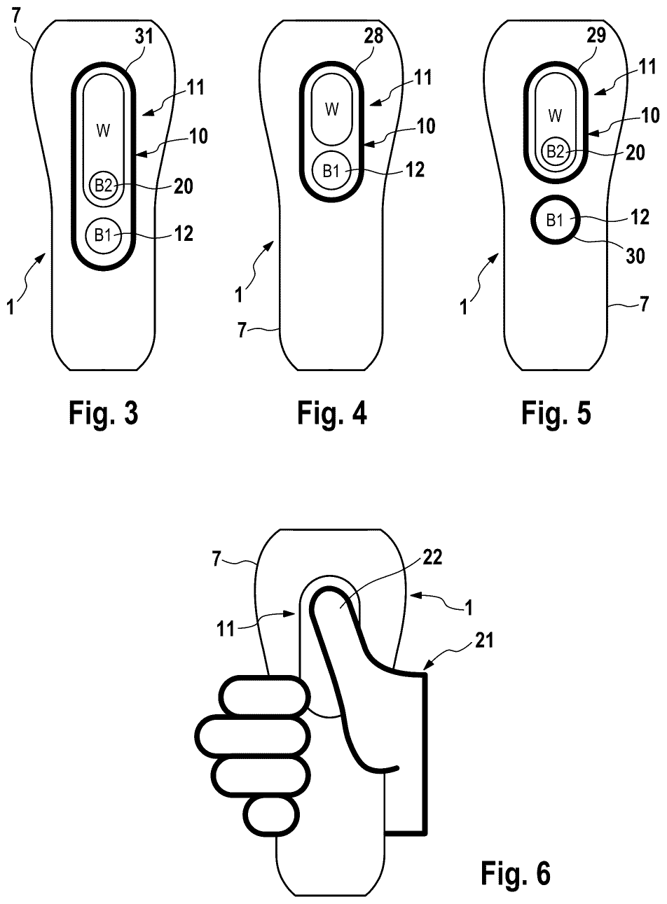

Said handle 1 is provided with an outer shell 7 made from metal as e.g. steel. Upper and lower plastic closures 9, 8 close the basically cylindrically shaped outer shell at the upper and lower end. The outer shell 7 may have different shapes with a narrower cross-section at the lower end and a wider cross-section at the upper portion. A horizontal cross-section of the outer shell 7 is rounded, preferably oval rounded with outwardly bulging portions, see also FIGS. 3-6. The outer shell has a cutout display opening 28 for receiving therein an outer window part 10, which is part of a display 11 and may receive an on/off button 12.

As per the cross-sectional view of FIG. 2 the handle 1 is also provided with an inner shell 13 which is substantially pot shaped and closed at the end portions with a sealing for watertight closure. The inner shell 13 is made from translucent or transparent thermoplastic material. The inner shell 13 encapsules inside a chassis part that holds a battery 15 at the lower end and a motor 16 at an upper end. The motor 16 is coupled with a drivetrain 17 for driving the cutting tools 5, 6.

A printed circuit board (PCB) 18 extends from the lower end to the upper end inside the inner shell 13 at the sides of the battery 15 and the motor 16. By this arrangement, the battery 15 and the motor 16 are electrically connected to the PCB 18 without longer electric connections. On the other side of the PCB 18, so opposite to the battery and the motor are a electric switch and an electronic display element 19 arranged and electrically connected to the PCB 18. Thus, the electronic display element 19 and the motor 16 are arranged adjacent to each other, separated only by the PCB 18 (and maybe part of the chassis 14) arranged between both of the motor and the electronic display element. The electronic display element 19 may be a TFT or LCD or other type of display mentioned above. The electronic display 19 faces directly the inner side of the inner shell 13, so that images visualized by the electronic display 19 can be seen though the inner shell 13. Alternatively, the electronic display element may consist of several LED lamps.

FIGS. 3 and 5 show different alternatives of the front side of the handle 1 as part of the shaver of FIGS. 1 and 2. FIG. 4 shows substantially the handle 1 of FIGS. 1 and 2. The outer contour line of the outer shell 7 in FIGS. 2 to 6 is more curved than in FIGS. 1 and 2 any may have still different shapes. FIGS. 3 to 5 shall visualize different arrangements of the shaver's user interface with the display 11 having an active displaying area “W”, the on/off button 12, here shown with “B1” and a t least one mode button 20 for changing a shaver functionality as e.g. shaver speed of head/cutting unit moveability, in the figures indicated with “B2”. It is to be noted that for all variants the position of the mode button and that of the on/off button may be swapped. FIGS. 3 and 5 show the mode button 20 (or alternatively the on/off button) as part of the active display area W so that it may be touch sensitive screen that allows activating the button without further traditional switching means needed. Alternatively, this button in FIGS. 3 and 5 may not be part of the display area but it may be provided as a designated button, separate from the display. For all examples the display is closest to the top end of the shaver and the button(s) are provided below that closer to the lower end of the shaver more remote from the cutting tool. In case however, of a button to be activated directly via the display, e.g. via a touch-screen or via gesture or similar display handling such button may be located in the lower end, the middle are or the top end (closest to the cutting tool) or all over the display extension. Advantageously, the examples of FIGS. 2 and 3 require only one display opening in the outer shell 7 in order to accommodate therein the display 11 and the on/off button with or without an extra mode button 20. The shape/contour line of this display opening 28, 29, 31 may be like a racetrack, oval or other longitudinal extending shape. For all figures the display opening 28, 29, 31 for the display and the buttons is shown with a contour line corresponding to a racetrack. Only for the example of FIG. 5 an additional circular opening 30 in the outer shell 7 is provided for a or another button. Therefore, the manufacturing is easier particularly if the outer shell in a non-injection molded plastic part but instead made of metal and less extra steps for cutting out the opening(s) is needed. A “race-track” shape is meant to have two half-circular ends and two parallel extensions connecting the half-circular ends.

FIG. 3 is an example having one race track shaped contour line of an interface module comprising all display(s) and buttons thereon. Here the display 11 is touch sensitive and allows to change an operation mode or a functionality by tipping or touching the “button” 20 on the display 11. An on/off button 12 moveably supported within the interface module is provided below the display 11.

FIG. 4 shows also a racetrack shaped contour line of an interface module having a display 11 in the upper area and an on off button 12 below that.

FIG. 5 is an example similar to that of FIG. 3 with however an own designated part for the on/off button 12 preferably circular shaped separate from the racetrack shaped outer window 10. The display 11 is again touch sensitive and allows changing the operation mode or functionality of the shaver by pressing onto the display button B2.

FIG. 6 shows the ergonomic advantages of the described display and button arrangement on a shaver handle 1. During use of the shaver the user's thumb may intuitively find the place in the racetrack shaped or other shaped display 11. The shape of the display 11 corresponds substantially with the shape needed as thumb rest. By a small vertical movement downwards the thumb 22 may move from the shown resting position on the display 11 towards the on/off button and/or a mode button 20. The display 11 may have a different outer shape then the adjacent shape of the outer shell 7, or in other words the display is not continuing the shape of the outer shell 7 at the location of the display 11. Preferably the outer window of the display is flat or plane in a middle area thereof. Further preferably the display with the outer window 10 is recessed or depressed. Thus, the thumb finds its way intuitively without need of an attention by the user for this.

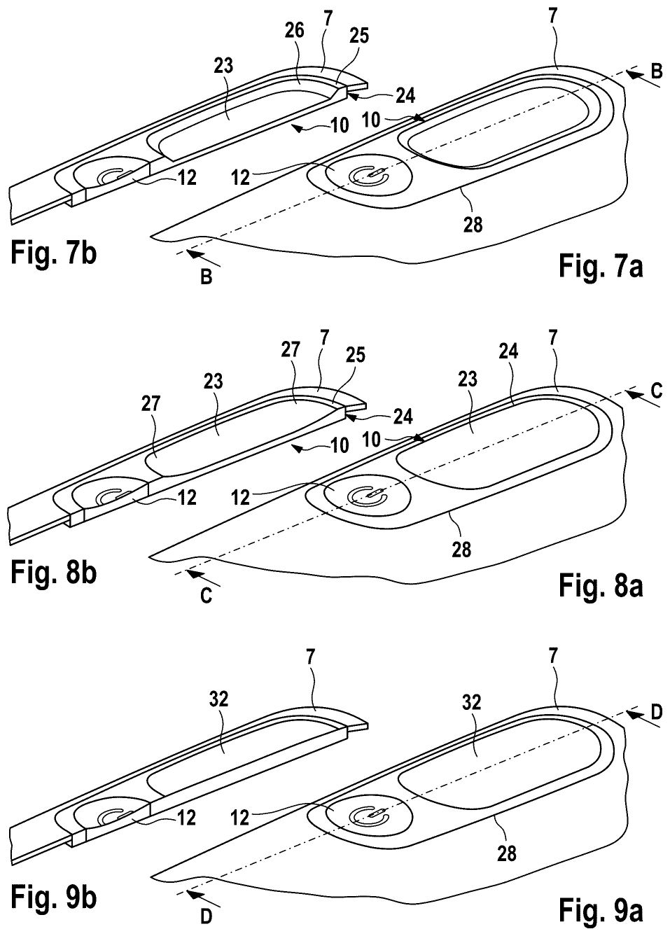

FIGS. 7a, 8a and 9a shows part of the handle 1 front side with different alternative shapes of the outer window 10 for the display 11. FIG. 7b is a cross-sectional view of FIG. 7a along line B-B in FIG. 7a. FIG. 8b is a cross-sectional view of FIG. 8a along line C-C in FIG. 8a. FIG. 9b is a cross-sectional view of FIG. 9a along line D-D in FIG. 9a.

The outer window part 10 includes all parts of the user interface for displaying functions of the shaver and for activating shaver functions including the on/off button and optionally additional mode buttons within single display opening 28 in the outer shell 7 of the shaver handle 1. It is provided with an upper area closer to the top end of the shaver with the cutting tool(s) for accommodating therein the display 11 and a lower area for an on/off button 12.

The shape for the on/off button is in all examples shown with FIGS. 7a, 8a and 9a the same, also the contour of the display 11 is the same. The examples are however differently configured in that the thumb rest area is established onto the display.

The example of FIGS. 7a, 7b is provided with an outer window part 10 framing a central main portion 23 by a rim portion 24. Said rim portion 24 includes an outer top portion 25 which is substantially flush mounted with the outer shell 7, so that no step in height is created. Said rim portion 24 also includes an inclined portion 26 between the top portion 25 and the main portion 23. Said inclined portion 26 is inclined by an angle of around 45 degree or alternatively by an angle ranging between 10-80 degree or 25 to 60 degree. The main portion 23 is flat or planar or plane or even, i.e not convexly or concavely curved. This flatness reduces ambient light reflections and defines a well recognizable thumb rest and allows touch screen functionality. The inclined portion 26 provides a finger stop functionality. By this configuration the main portion 23 is recessed or depressed relative to the framing top portion of the display's outer window part 10. This depression protects the main portion against scratches and provides ergonomic thumb rest properties. The electronic display element 19 is provided inside and directly adjacent of the main portion 23 of the outer window part 10.

The outer window 10 of the example of FIGS. 8a, 8b is still provided with a flat or planar main portion 23 but is provided with no inclined portion or a low angle inclined portion.

The outer window 10 of the example of FIGS. 9a, 9b is also provided with main portion 32 which is not planar or flat but depressed or concave or curved. It is outwardly curved following the outer shape of the outer shell 7. Alternatively, it is inwardly curved. Thumb rest properties are provided by a surface texture which is different from the outer shell 7. E.g., the thumb rest surface of the main portion 32 may be coated to enhance the gripping relative to a less enhanced grip property of the adjacent outer shell surface.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hair cutting device, such as an electric shaver or trimmer, comprising a handle and a hair cutting tool, said hair cutting tool is provided within a head which is supported such on said handle to allow swivel motion of said head and said cutting tool comprises at least three separate hair cutting units. said handle being provided with an outer shell, a PCB, a battery, a motor, an on/off button or switch, a display for indicating a functional status of the device by at least one of images, text, figures symbols, wherein a part of said display and said on/off button or switch being electrically connected to first side of said same PCB and said battery and said motor being electrically connected to a second side of said same said PCB opposite to said first side, wherein said on/off button being provided on a same frontal side of said outer shell as said display and wherein said hair cutting tool being located at a top end of the device opposite to a bottom end thereto, wherein said display being provided closer to the top end of the device than said on/off button and wherein said display also forming a thumb rest area.

2. The hair cutting device in accordance with claim 1, wherein said outer shell is provided with a display opening, said display comprises an outer window part fitting in said display opening and said part of said display connected to said PCB includes an electronic display element and wherein said outer window part includes central main portion and a rim portion.

3. The hair cutting device in accordance with claim 2, wherein said outer window part is a one-piece part made from plastic and is formed with a depression and/or wherein said rim portion is substantially flush mounted with the adjacent outer shell and said central main portion is recessed or depressed relative to the rim portion.

4. The hair cutting device in accordance with claim 2, wherein said outer window part is translucent and dark colored.

5. The hair cutting device according to claim 2, wherein said outer window part is 2-component injection molded part having a transparent central main portion and a non-transparent rim portion.

6. The hair cutting device in accordance with claim 2, wherein said on/off button is part of the outer window part.

7. The hair cutting device in accordance with claim 2, wherein said rim portion is provided with a at least 0.5 mm wide top portion which is flush mounted with outwardly adjacent outer shell and is provided with an inwardly adjacent inclined portion, wherein said inclined portion connects the central main portion with the top portion.

8. The hair cutting device according to claim 1, wherein said display, said PCB and said motor are positioned next to each other side by side with the PCB being located between said display and said motor.

9. The hair cutting device according to claim 1, wherein said thumb rest area is depressed or recessed relative to the outer shell.

10. The hair cutting device in accordance with claim 1, wherein said display is provided as one of a LCD, TFT, Touch-display, QLED, OLED, LED's, AMOLED, or Super AMOLED type.

11. The hair cutting device in accordance with claim 1, wherein said display includes a sensory area for activating and/or deactivating a hair cutting device function.

12. The hair cutting device accordance with claim 1, wherein said display allows for gesture or finger swipe control of a hair cutting device function

13. The hair cutting device in accordance with claim 1, wherein said outer shell is made of metal.

14. The hair cutting device in accordance with claim 1, wherein said display is provided with an electronic display element and a water sealed inner shell is provided for accommodation therein of said PCB, an electronic display element, battery, and motor.

15. The hair cutting device in accordance with claim 1, wherein a user interface includes said display and said on/off button and/or at least one mode button and wherein said outer shell is provided with a single display opening for accommodating therein all parts of the user interface and/or wherein said outer window part is provided with the user interface.
